(19) United States
(12) Patent Application Publication
(10) Pub. No.: US 2014/0048757 A1
(43) Pub. Date: Feb. 20, 2014

(54) METHOD AND APPARATUS FOR MANUAL EXTRACTION OF IN GROUND OBJECTS

(71) Applicant: Robert Arthur DeNyse, JR., Buford, GA (US)

(72) Inventor: Robert Arthur DeNyse, JR., Buford, GA (US)

(21) Appl. No.: 13/586,455

(22) Filed: Aug. 15, 2012

(51) Int. Cl. A01G 23/06

(52) U.S. Cl. 254/131

(57) ABSTRACT

The present invention includes a tool for extracting objects that are embedded in the ground; such as plants, posts, and cables. The extractor comprises a puller pole attached to a curved fulcrum and a parallel, offset, engagement pole. The object extractor includes a locator used for aligning objects with the object extractor. The engagement pole incorporates cabling and ratcheting systems, which assist in the tightening of the embedded object to the apparatus. An individual then applies sufficient pulling force to the puller pole resulting in extraction of the object from the ground.

### FIELD OF THE INVENTION

This invention generally relates to landscape maintenance tools. Particularly, embodiments of this invention relate to tools used in the extraction of objects from the ground. More particularly, embodiments of this invention relate to devices for use in up rooting plants, trees, poles and cables from the ground.

### BACKGROUND OF INVENTION

The extraction or uprooting of undesirable objects embedded into the ground, including but not limited to plants, posts, and cables, remains an important means of clearing small areas of landscape by homeowners, public park maintenance staff, landscape businesses, and the like. Resorting to utilizing picks, shovels, and brute force to pull these objects out of the ground typically requires very intense labor that is both time-consuming and potentially injurious to the user. Some tools have become viable options for solving these problems. However, these existing devices do not entirely resolve those problems and present their own shortcomings.

As one example, U.S. Pat. No. 640,889, hereinafter referred to as Dunbar, discloses a Tree Extractor and Carrier. This tool provides a means of leverage to extract trees using a stationary fulcrum. The use of a stationary fulcrum is undesirable, because stationary fulcrums do not provide the additional advantages where movement of a fulcrum in an upward and backward direction provides additional pulling power to the user that will help to extract an object from the ground. When a fulcrum is stationary, not only is the effort to remove the in ground object laborious may also cause significant injury to the user. In addition, because of the configuration of the device of Dunbar, it is rather tedious to properly position the roping systems and apply the force necessary to remove the tree.

Additionally, the tool in Dunbar is used in conjunction with motorized vehicles like a tractor or a motorized device with a means of hoisting. The tool is attached to the motorized device and driven forward, uprooting the object from the ground as the motorized device moves. However, it is not always feasible or desired to utilize a motorized vehicle, particularly for the extraction of smaller in ground objects.

U.S. Pat. No. 4,856,759 hereinafter referred to as Ness, employs two grabber surfaces that contact opposing sides of an object's base, thus creating a sandwich structure which pinches the in ground object between two gripping surfaces. Although the flat gripping surfaces of the grabbers are textured to facilitate gripping of the plant, the grabbers can nevertheless slip off the object, especially if insufficient grabbing force is applied by the individual using the tool. This grabber configuration provides significant disadvantages because the grip applied by the tool depends on the user. This applied grip may not be adequate enough to hold the object while it is being pulled from the ground. Additionally, just as shown in Dunbar, the fulcrum of the Ness tool is stationary and therefore has the same shortcomings as Dunbar.

U.S. Patent Publication US 2009/0194300 A1, hereinafter referred to as Oberg, discloses a similar configuration to Ness, where two pinching and grabber surfaces are used in conjunction with a stationary fulcrum is shown. Thus, Oberg has similar shortcoming as those described with respect to Ness.

U.S. Pat. No. 3,201,089, hereinafter referred to as Napoletano, discloses an “Uprooting Device.” This device exerts concurrent but opposing actions between a stationary fulcrum placed at the base of a tree and a hydraulic jack system placed higher along the length of the tree that provides a thrusting means against the tree. Subsequently, these actions results in uprooting the tree. Although this device works well for tall and sturdy trees, smaller trees and shrubs are too pliable for the operation of this device to be successful in extracting smaller items. Another significant disadvantage of this device is its heavy weight that may pose functional problems when used in soft soils or gravel.

It is necessary in many gardening and farming environments to extract in ground objects with the use of a motorized vehicle, however, the user may prefer to conduct the extraction manually. In addition, it is sometimes necessary for the user to be able to extract in ground objects manually, without the use of large, heavy hydraulic lifts. Therefore, there remains a need for a landscaping tool which will allow an individual to easily extract objects of varying sizes and shapes from the ground.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

By way of the present invention and in distinction of today's systems, the extraction device of the present invention can be utilized to manually extract in ground objects without additional use of motorized vehicles, large or heavy hydraulic equipment, or high risk of injury. The disclosed innovative apparatus can be positioned to secure and remove an in ground object using a cable and locator system. In each embodiment, the user can then ratchet a cable of the extractor system to tighten the cable system around the in ground object, and apply a backward and downward motion. This backward and downward motion will pull and lift the extraction device along its moving fulcrum, leading to the extraction of the object from the ground.

In one embodiment, the present invention provides an improved means of avoiding slippage between the apparatus and the in ground object by the use of the ratchet and cable system. This is accomplished by the concerted action of the cable/ratchet/locator systems whereby the entire circumference of the in ground object's base is in tight contact with the locator, thus allowing the locator to be used as a base and connection point to provide leverage to push and pull the in ground object from soil or any other medium it is in.

It is yet another object of the present invention to provide a tool that can be transported by a single person to the area of interest.

Finally, the present invention is to provide a more accurate and flexible means of positioning the extractor relative to the object by means of an adjustable locator. In that embodiment, the locator can be slid or positioned in various ways so as to be offset from the center of the apparatus and at varying heights to facilitate solid connection of the locator to the in ground object. This embodiment allows the apparatus to be positioned in spaces that are not conducive to the locator being locked in one position and thereby difficult to use in those spaces.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and description will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a front view of the extractor device in accordance with the present invention.

FIG. 2 is a side view of the extractor device in accordance with the present invention.

FIG. 3 is a perspective view of the extractor device in accordance with the present invention.

FIG. 4 is an exploded view of extractor device in accordance with the present invention.

FIG. 5 illustrates several alternate embodiments of the locator, where the locator is adjustable and replaceable with multiple configured locators that are made to fit different types and sizes of in ground objects.

FIG. 6 illustrates the extractor in accordance with this invention attached to an in ground object to facilitate removal of that object.

FIG. 7 illustrates the use of the extractor by a user in accordance with this invention.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims. Furthermore, the figures, which are not necessarily drawn to scale, are not intended to limit the scope of the present invention contemplated by skilled artisans who will realize alternative embodiments taught within the scope of the present invention. In other instances, well known components, materials or methods have not been described in detail in order to avoid obscuring the invention. Therefore, specific structural and functional details disclosed herein are not to be interpreted as limiting, but merely as a basis for the claims and as a representative basis for teaching one skilled in the art to variously employ the invention.

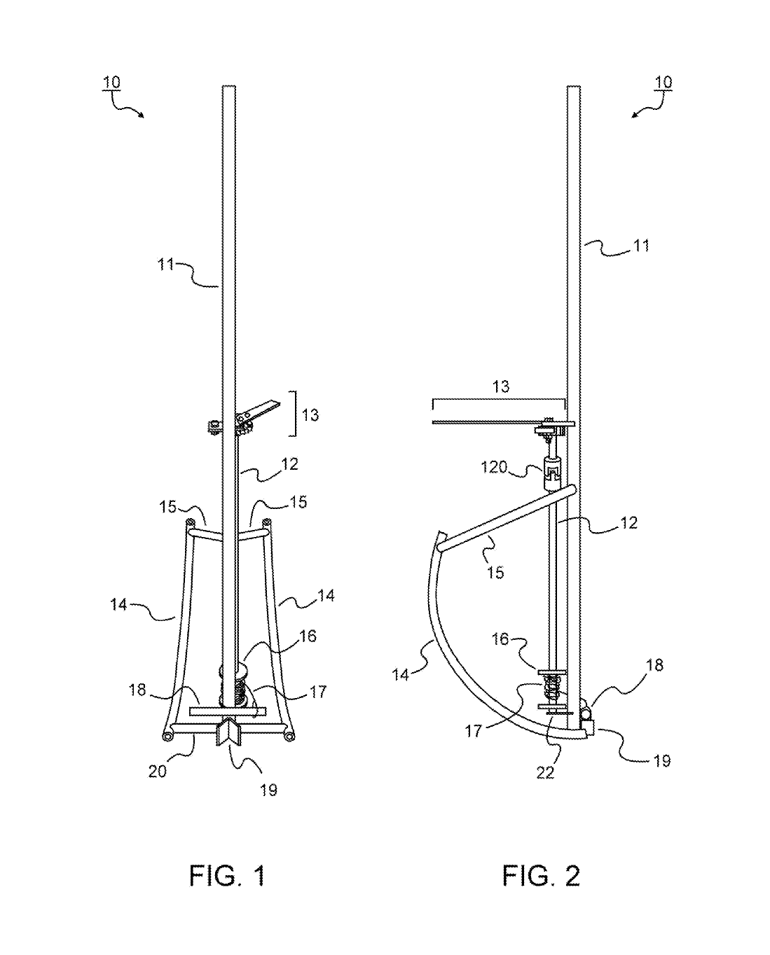

Referring now to the drawings, and in particular FIG. 1 through FIG. 7, provides principles and concepts to enable a person skilled in the art to make and use a new object extractor device, herein designated by reference number 10. The extractor device 10 may be made of any suitable material having strength and durability to allow a user to exert force on the extractor so as to not break the device, such as steel, PVC, or any other metal, alloy, composite, or plastic. One of ordinary skill in the art will recognize that the materials listed are not limited to those listed herein. Throughout the several views depicted in the drawings, the same reference numerals pertain to the same elements.

FIGS. 1 and 2 illustrate the extractor device 10. As shown in FIG. 1, the extractor device 10 comprises a puller pole 11 attached to a curved fulcrum 14 via both interconnectors 15 and crossbar 20. An engaging pole 12 is parallel to the puller pole 11 and separately connected to the puller pole 11, by way of both the ratchet system 13 and the cable spool connector 22 (shown in FIG. 2), in such a manner to position the engaging pole 12 slightly offset relative to the puller pole 11. The curved fulcrum 14 is configured such that the bottom leg of the curved fulcrum 14 is longer than the top leg, so that as the extractor 10 is used, the bottom leg facilitates additional lifting height as the extractor 10 is pulling the in ground object. While this feature is not necessarily shown in the drawing, as the drawings may not be to scale, it is noted that this is an intended feature and within the scope of the present invention. Additionally, the puller pole 11 and engaging pole 12 are offset to reduce tension on the cable spool 16 and engaging pole 12 in relation to cable 17 while in use. The cable 17 is made of a material of any suitable strength and tension capable of solidly securing the cable 17 to an in ground object including, but not limited to, metals, fibers, plastic or any combination thereof. The engaging pole 12 is connected to ratchet system 13, cable spool 16, and cable 17, whereby when the user can engage the ratchet system 13 to turn the cable spool 16 and ratchet cable 17 around the in ground object. As a result of this ratcheting action, the cable 17 is also wound around the cable spool 16. A cable support bar 18 is perpendicular and attached to the puller pole 11. The cable support bar 18 is used to prevent the cable 17 from sliding down the object or the puller pole. The cable support bar 18 keeps the force on the cable 17 perpendicular to the cable spool 16. The locator 19 is positioned such that the locator 19 will be securely abutted against the in ground object so as to facilitate leverage against and removal of the in ground object as the user pulls and/or rocks the extractor 10.

FIG. 2 illustrates a side view of the extractor device 10. In this embodiment, the engaging pole 12 includes a misalignment coupler 120 to prevent the engaging pole 12 from binding due to excessive use or over-torque on the ratcheting system 13 against the cable 17. The misalignment coupler 120 can be any coupling device that is capable of disengaging itself or reducing the rotational force applied from ratchet system 13 against the engaging pole 12.

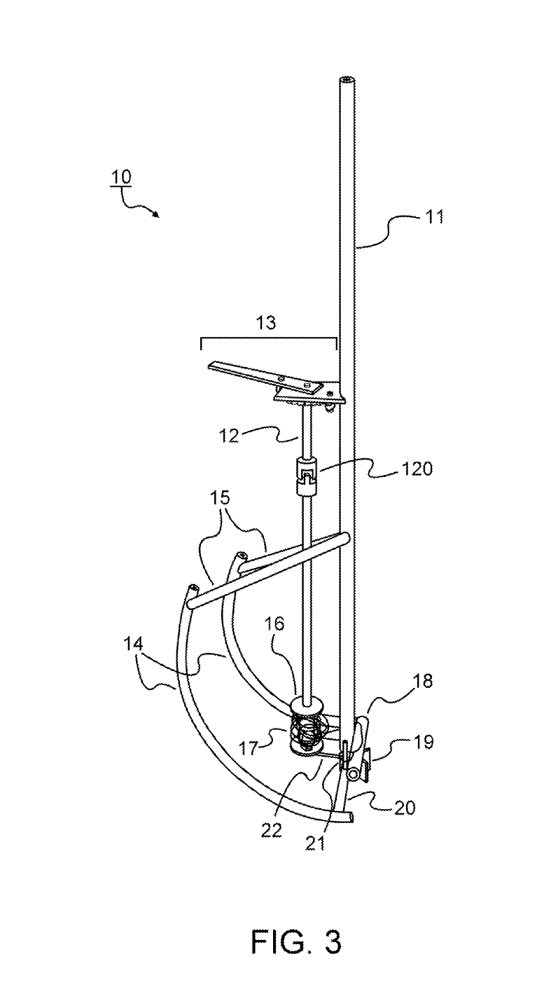

FIG. 3 illustrates a perspective view highlighting additional features of the extractor device 10. FIG. 3 also illustrates support bar 18 and cable dowel 21 attached to the puller pole 11. The cable dowel 21 and the support bar 18 can be used to secure cable 17 around the in ground object and prevent the cable 17 from sliding off the in ground object.

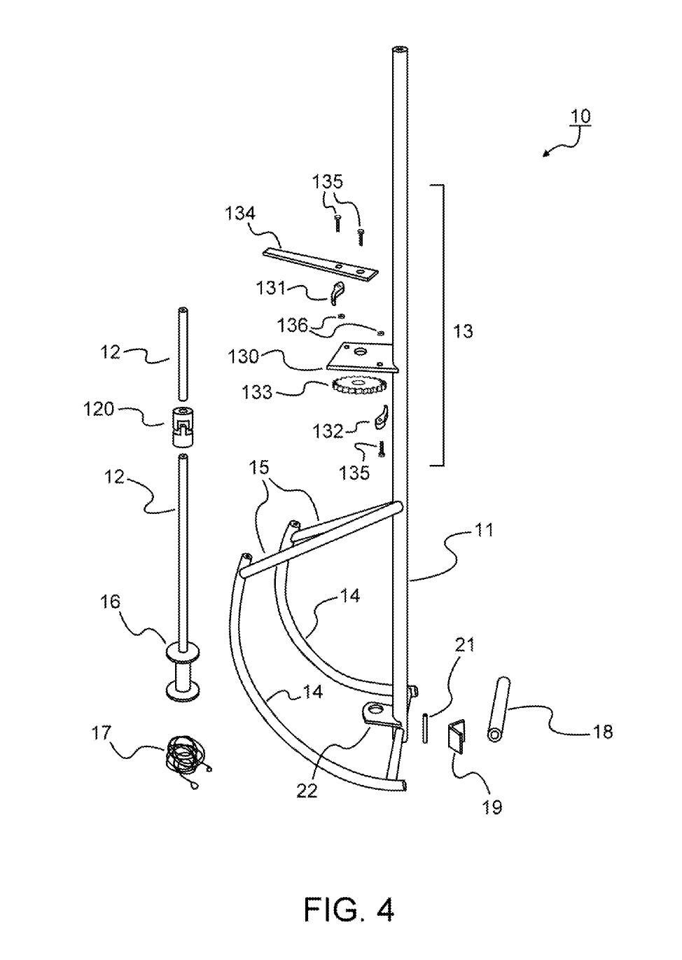

With reference to the exploded view of FIG. 4, the ratchet system 13 comprises a sprocket platform 130, sprocket engager 131, sprocket lock 132, sprocket 133, and a ratcheting lever 134. Each of these are secured by nuts 136 and bolts 135. The sprocket 133 is connected to the engaging pole 12. The ratcheting lever 134, sprocket platform 130, sprocket engager 131, and sprocket lock 132 are all connected by nuts 136 and bolts 135. Each of the objects, the engaging pole 12, misalignment coupler 120, cable spool 16, interconnectors 15, curved fulcrum 14, cable spool connector 22, puller pole 11 and support bar 18 were shown and described with reference to FIGS. 1, 2 and 3.

Once the in ground object has been aligned with a locator 19, secured by the cable 17, and the cable 17 has been secured to the cable dowel 21, the user can then begin to tighten the cable 17 by using the ratchet system 13. The sprocket 133, sprocket engager 131, sprocket lock 132, and ratcheting lever 134 all interact to create the ratcheting system 13 and engaged to tighten the cable 17. For the extraction device 10 to work effectively, the sprocket lock 132 must be locked into place. The sprocket lock 132 contains a tensioned spring which will cause the sprocket lock 132 to continually engage and re-engage with the sprocket 133 teeth as the ratcheting motion occurs. The sprocket lock 132 serves a dual purpose, first as a stopper to prevent the sprocket 133 from rotating counter to the tightening motion of the ratcheting lever 134, and second, it serves as a release mechanism once the cable 17 has been fully tightened and an in ground object has been removed. There, the sprocket lock 132 can be disengaged to cause the sprocket 133 to spin in counter rotational direction to loosen the cable 17 to then release the in ground object. Once the sprocket lock 132 is locked in place, the user will begin a ratcheting motion using the ratcheting lever 134. The sprocket engager 131 also contains a tensioned spring which will cause the sprocket engager 131 to continually re-engage with the sprocket 133 teeth as the ratcheting motion occurs.

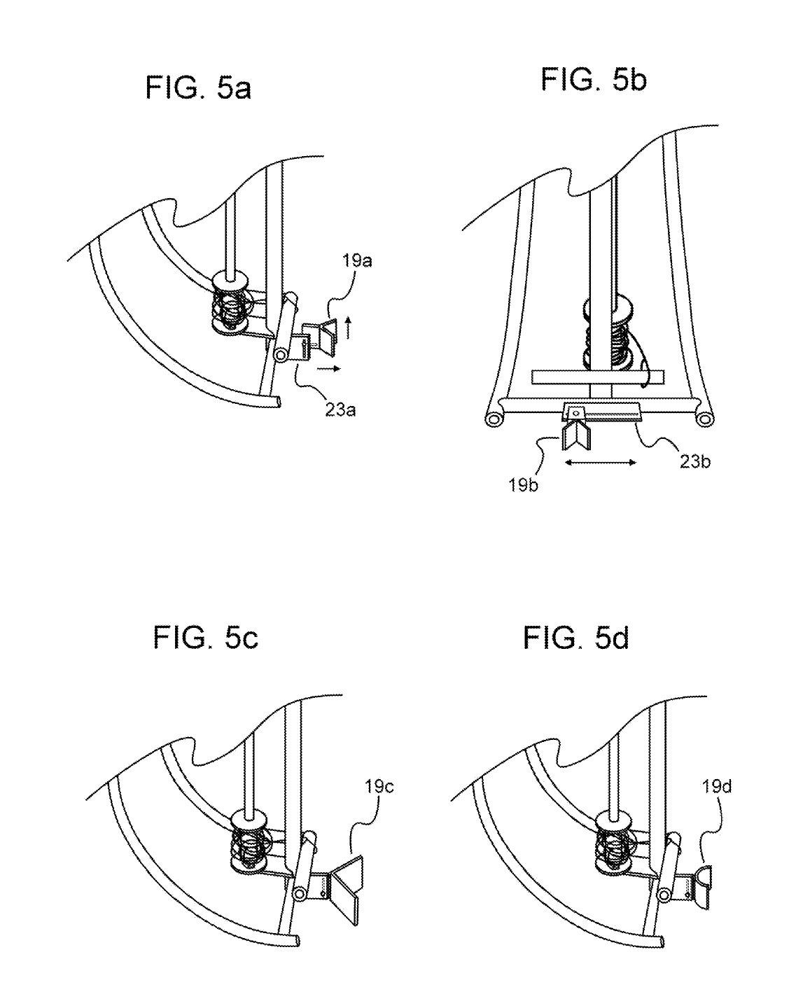

FIGS. 5a-5d depict an alternate embodiment of the proposed invention where the locator 19, coupled to the crossbar 20, is adjustable and removable to accommodate for various sizes and locations of in ground objects. The locator 19 assists in preventing in ground objects from sliding off the extractor device 10 during operation. Several removable locators 19 having varying shapes and dimensions may be used to accommodate extraction of in ground objects of varying shapes and sizes. As depicted in FIG. 5a, the locator 19a can be adjusted in either the horizontal plane and/or the vertical plane in reference to the locator attachment 23a. Furthermore, in some scenarios, the extractor device 10 cannot be positioned in such a way that allows the object to be centrally aligned with respect to the front of the extractor device 10. Thus, the locator 19a can be adjusted for optimal positioning to extract in ground objects at various heights or positions within tight spaces.

Another alternate embodiment, accommodating optimal positioning of the extractor device 10, is shown in FIG. 5b. In FIG. 5b, the locator 19b is capable of moving in varying positions, using the locator variable adjustor 23b, along the horizontal length of the crossbar 20.

A further alternate embodiment of the extractor device 10 may include locators 19 of various sizes 19c, or locators of various shapes 19d. For example, the locator 19 may be styled in a “v”-shaped 19c or semi-circle 19d shaped manner, having various angular degrees and curvatures.

Without departing from the scope of this invention, it should also be realized that the locator 19 can be configured to have hooks or bars, and the like, where the in ground object is a spool of cabling or a concrete slab, so that the hooks or bars can be used to extract those objects from the ground.

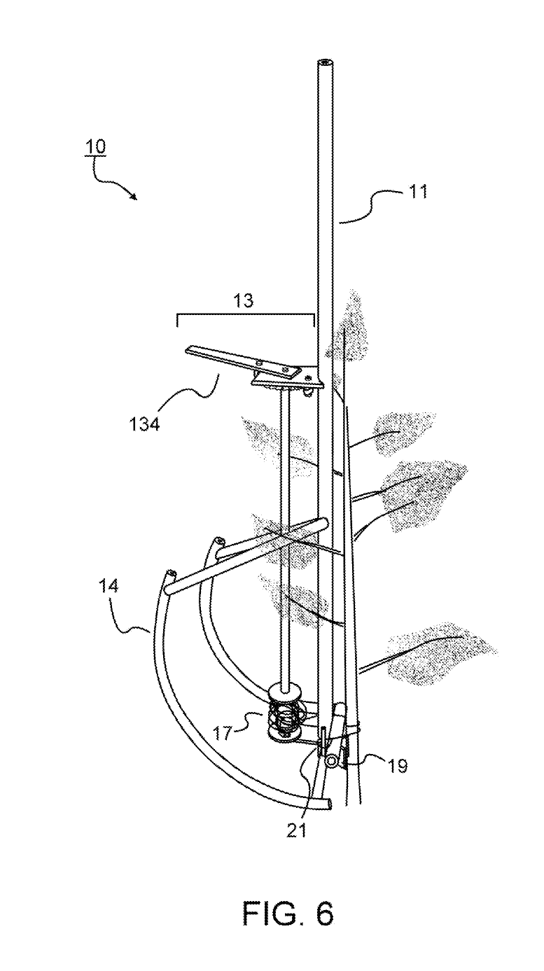

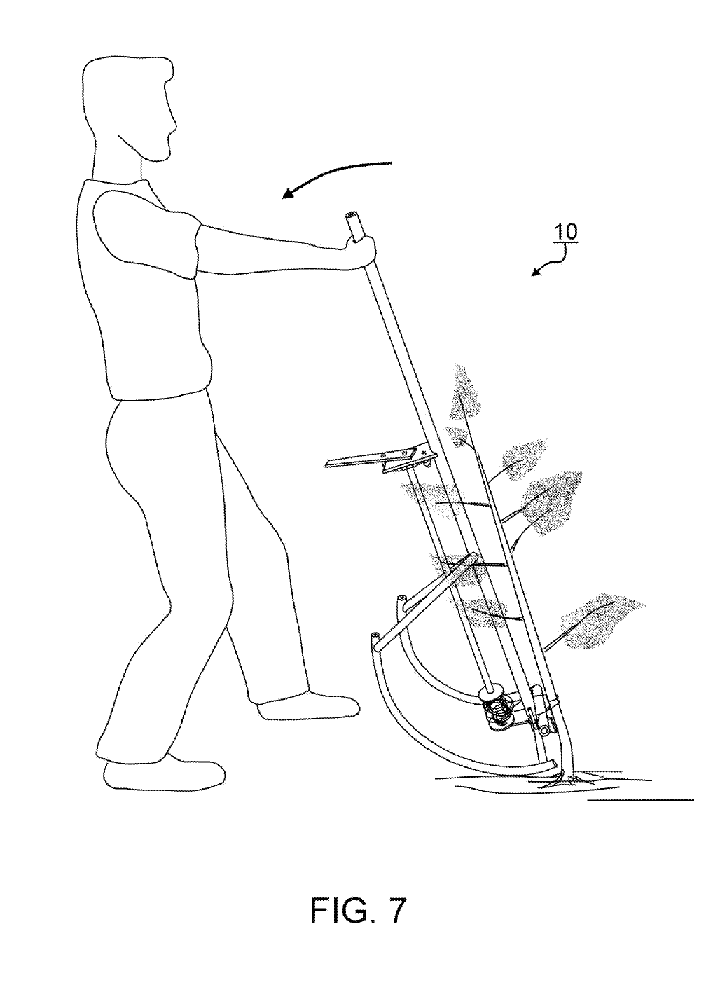

FIG. 6 shows the extractor device 10 coupled to the in ground object to be removed. Here, a tree is shown. The tree is secured into the locator 19 by unspooling the cable 17 from the cable spool 16 of the offset engaging pole 12. The cable 17 is securely wound around the base of the tree and the cable 17 is then affixed to the cable dowel 21. The ratchet lever 134 of the ratchet system 13 is then used to tighten the cable 17 removing any slackness in the cable 17 and thereby, securing the tree to the extractor device 10. Once the user has securely strapped the object to the locator 19 via the ratcheting system 13, the user will manually pull the puller pole 11 in a backward and downward motion causing the curved fulcrum 14 to pivot as depicted in FIG. 7. This pivoting motion translates into a lifting motion that causes the object to be extracted from the ground.

In any given embodiment, the extractor device 10 may include a singular fulcrum or plurality of fulcrums 14 for a greater ease of movement and a reduction of strain on the user. Additionally, the puller pole 11 may also incorporate various gripping members including, but not limited to, handle bars, horizontal bars or curved bars to facilitate an improved means for the user to grasp and pull the puller pole 11.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An apparatus for extracting in ground objects comprising:
a puller pole;
an engaging pole, wherein a ratchet system is connected to the engaging pole for rotating a cable system used to secure the in ground object to apparatus to aid in extracting the in ground object;
at least one curved fulcrum attached to the puller pole, wherein a first leg of the curved fulcrum is shorter than a second leg of the curved fulcrum; and
a locator attached to a crossbar.

2. The apparatus of claim 1, wherein the puller pole and the engaging pole are parallel relative to each other.

3. The apparatus of claim 1, wherein the puller pole comprises of a handle member.

4. The apparatus of claim 1, wherein the ratchet system is comprised of a sprocket platform, a sprocket, a sprocket lock and release mechanism, and a handle for turning the ratchet system.

5. The apparatus of claim 4, wherein the sprocket platform is attached to the puller pole.

6. The apparatus of claim 4, wherein the sprocket is attached to the engaging pole.

7. The apparatus of claim 1, wherein the cable system comprises a cable spool, a cable, and a cable dowel.

8. The apparatus of claim 7, wherein the cable has an attachment mechanism to secure itself to the extractor device.

9. The apparatus of claim 7, wherein the cable spool is attached to the engaging pole.

10. The apparatus of claim 1, wherein the cross-bar is attached to the puller pole.

11. The apparatus of claim 1, wherein a stopper is attached to each end of the cross bar so as to retain the cable on the bar until the cable is tightened.

12. The apparatus of claim 1, wherein an engaging pole platform is attached to the puller pole while allowing the engaging pole to rotate.

13. The apparatus of claim 1, wherein the locator is attached to the crossbar by mechanism variable adjustor.

14. The apparatus of claim 1, wherein the locator is detachable.

15. A method for removal of an in ground object using a extractor device, comprising the steps of:
placing a locator against the in ground object to be removed,
securing the in ground object to the locator with a cable;
securing the cable to a cable dowel;
adjusting a ratchet lever to tighten the cable around the in ground object; and
pulling the extractor device to pivot a fulcrum of the extractor device so that the secured cable causes the in ground object to be removed from the ground.

16. The method of claim 15, wherein centering the locator is adjustable in a vertical plane.

17. The method of claim 15, wherein the locator is adjustable in a horizontal plane.

18. The method of claim 15, wherein securing the locator is removable and configured to accommodate different sizes of in ground objects.

19. The method of claim 15, wherein the locator is adjustable and configured to accommodate different shapes of in ground objects.
